(19) United States
(12) Patent Application Publication
(10) Pub. No.: US 2004/0246042 A1
(43) Pub. Date: Dec. 9, 2004

(54) [BALANCE APPARATUS FOR LINE INPUT CAPACITORS ]

(76) Inventor: Ta-Yung Yang, Milpitas, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,806

(22) Filed: May 9, 2003

(51) Int. Cl. H02J 1/00

(52) U.S. Cl. 327/530

(57) ABSTRACT

The present invention provides a balance apparatus for line input capacitors. A programmable N-current-sink is connected in parallel to a high-side capacitor, and a programmable P-current-sink is connected in parallel to a low-side capacitor. A resistor network is coupled between the high-side capacitor and the low-side capacitor to generate a differential voltage. The differential voltage is the voltage difference of the high side capacitor and the low side capacitor. When the voltage of the high-side capacitor is higher than the voltage of the low-side capacitor, the programmable N-current-sink will sink an N-current that is proportional to the differential voltage. If the voltage of the low-side capacitor is higher than the voltage of the high-side capacitor, the programmable P-current-sink will sink a P-current that is also proportional to the differential voltage. When the differential voltage is small, both the N-current-sink and the P-current-sink will be turned off to reduce power consumption.

### BACKGROUND OF INVENTION

### Field of the Invention

The present invention relates to the art of power supplies and more specifically relates to switching power supplies.

FIG. 1 shows the input stage of a traditional switching power supply. The input AC voltage (V_{IN}) is rectified by bridge diodes 101, 102, 103 and 104. A high-side capacitor 200 and a low-side capacitor 300 filter the input signal to obtain the DC voltage V_{B}. The voltage at a positive terminal of the high-side capacitor 200 is the DC voltage V_{B}. A negative terminal of the high-side capacitor 200 is connected with a positive terminal of the low-side capacitor 300. A negative terminal of the low-side capacitor 300 is connected to the ground reference.

If the input voltage signal V_{IN} is between 180V_{AC} to 264V_{AC}, a switch 100 will be opened. The DC voltage V_{B} is equal to √2 times V_{IN} and hence V_{B} will be in the range from 254V_{DC} to 373V_{DC}. If V_{IN} is between 90V_{AC} and 132V_{AC}, the switch 100 will be closed to boost the DC voltage V_{B}. The DC voltage V_{B} will then be equal to 2√2 times V_{IN}. The switch 100 will operate to maintain V_{B} within the range from 254V_{DC} to 373V_{DC}.

While the switch 100 remains open, the voltages across the capacitors 200 and 300 are given by the following equations:

$$\begin{matrix}{V}_{C200} = \frac{{C}_{300}}{{C}_{200} + {C}_{300}} \times {V}_{B} & ( 1 ) \\ {V}_{C300} = \frac{{C}_{200}}{{C}_{200} + {C}_{300}} \times {V}_{B} & ( 2 )\end{matrix}$$

If the capacitance of the capacitor 200 is different from that of the capacitor 300, the voltages across the two capacitors will also be different. In practice, the absolute maximum voltage of both capacitors is typically limited to about 200V. If the variation of the capacitances of the two capacitors is high, the capacitors could be damaged.

Thus, a bleeding resistor 410 and a bleeding resistor 420 are required to compensate for the effects of impedance differences between the capacitors 200 and 300. The resistances of the bleeding resistors 410 and 420 should be relatively low, if the difference between the capacitance of the capacitor 200 and the capacitance of the capacitor 300 is high. Typically, the bleeding resistors 410 and 420 are designed to cope with worst-case scenarios. Thus, the resistors tend to consume significant amounts of power.

FIG. 2 shows a half-bridge topology, in which the need for voltage balancing across the capacitors 200 and 300 is even more demanding. If the voltages of the capacitors 200 and 300 differ, the energy switching of the switches 540 and 550 will also differ. Moreover, the energy used to switch a transformer 500 back and forth will be unbalanced, and therefore may easily cause transformer saturation.

### SUMMARY OF INVENTION

The present invention provides a balance apparatus for line input capacitors. One object of the present invention is to regulate the voltage across line input capacitors, so that they will be balanced. According to the present invention, the impedance of line capacitors will be automatically adjusted when the voltage across the line input capacitors begins to develop an imbalance. Therefore, the present invention achieves balanced line-input capacitor voltages.

Another object of the present invention is to reduce power consumption. According to the present invention, the balance apparatus only consumes power while correcting the imbalance in the capacitances. A programmable N-current-sink and a programmable P-current-sink are connected in parallel to a high-side capacitor and a low-side capacitor, respectively. A resistor network is added between the high-side capacitor and the low-side capacitor to generate a differential voltage. The differential voltage is the voltage difference of the high-side capacitor and the low-side capacitor. When the voltage of the high-side capacitor is higher than the voltage of the low-side capacitor, the programmable N-current-sink will sink a current that is proportional to the differential voltage. If the voltage of the low-side capacitor is higher than the voltage of the high-side capacitor, the programmable P-current-sink will sink a current that is also proportional to the differential voltage. When the differential voltage is small, both the N-current-sink and the P-current-sink will be turned off, thus reducing power consumption. Furthermore, according to the present invention, bleeding resistors of the prior-art are no longer necessary. This aspect of the present invention will further reduce power consumption.

It is to be understood that both the foregoing general descriptions and the following detailed descriptions are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows the input stage of a prior-art switching power supply with forward topology.

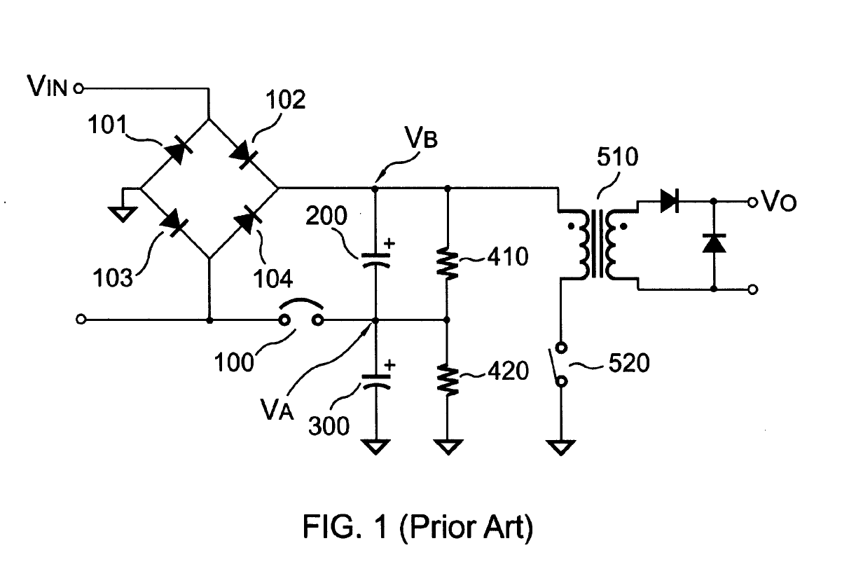

FIG. 2 shows another prior-art switching power supply with half-bridge topology.

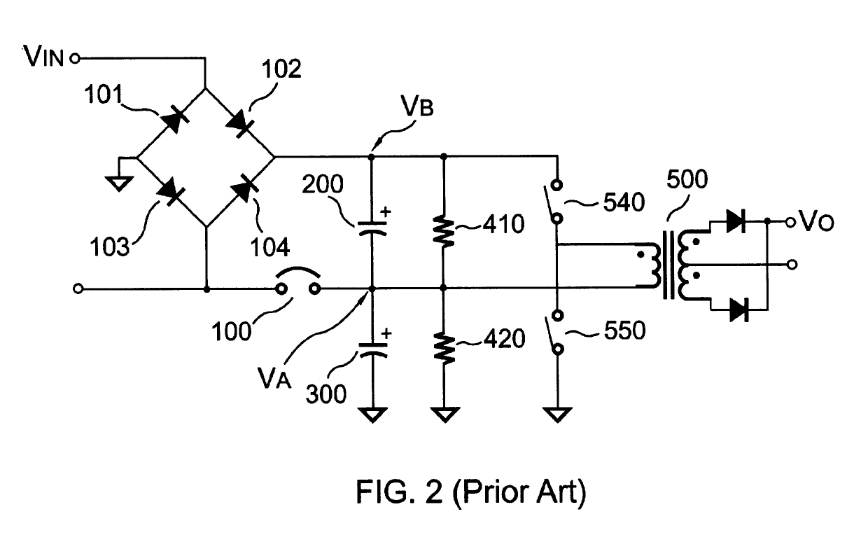

FIG. 3 shows a balance apparatus for line input capacitors according to a preferred embodiment of the present invention.

FIG. 4 shows another preferred embodiment of a balance apparatus for line input capacitors according to the present invention.

FIG. 5 further shows another preferred embodiment of a balance apparatus for line input capacitors according to the present invention.

### DETAILED DESCRIPTION

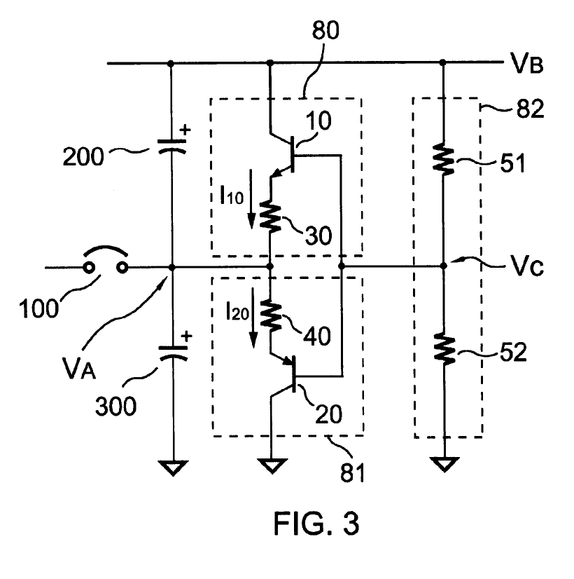

FIG. 3 shows a balance apparatus for line input capacitors according to a preferred embodiment of the present invention, in which the balance apparatus comprises a N-current-sink 80, a P-current-sink 81 and a resistor network 82. The resistor network 82 comprises a high-side resistor 51 and a low-side resistor 52. The N-current-sink 80 includes an n-p-n transistor 10 and a N-resistor 30. The P-current-sink 81 includes a p-n-p transistor 20 and a P-resistor 40. A collector of the n-p-n transistor 10 is connected to a positive terminal of a high-side capacitor 200. The voltage at the positive terminal of the high-side capacitor 200 is the DC voltage V_{B}. The voltage at the positive terminal of a low-side capacitor 300 is the voltage V_{A}, which is connected to a negative terminal of the capacitor 200. A negative terminal of the low-side capacitor 300 is connected to a ground reference. Through the N-resistor 30, an emitter of the n-p-n transistor 10 is connected to the negative terminal of the capacitor 200. The high-side resistor 51 and the low-side resistor 52 are connected in series between the DC voltage V_{B} and the ground reference. A base of the n-p-n transistor 10 is connected at a junction of the high-side resistor 51 and the low-side resistor 52. Through the P-resistor 40, an emitter of the p-n-p transistor 20 is connected to the positive terminal of the low side capacitor 300. A collector of the p-n-p transistor 20 is connected to the ground reference. A base of the p-n-p transistor 20 is connected at the junction of the high-side resistor 51 and the low-side resistor 52.

The resistance of the high-side resistor 51 is equal to the resistance of the low-side resistor 52. Thus, the voltage V_{C} is equal to the voltage V_{A}, if the voltage across the high-side capacitor 200 is equal to the voltage across the low-side capacitor 300. When the voltage V_{C} is equal to the voltage V_{A}, both the n-p-n transistor 10 and the p-n-p transistor 20 will be turned off. If the voltage across the high-side capacitor 200 is higher than the voltage across the low-side capacitor 300, then the voltage V_{C} will be higher than the voltage V_{A}. This will result in the p-n-p transistor 20 being turned off, and the n-p-n transistor 10 being turned on. A current I₁₀ will be sunk from the high-side capacitor 200. The current I₁₀ will be proportional to a differential voltage, which is the difference of the voltage V_{C} and the voltage V_{A}. With R₃₀ as the resistance of the resistor 30, and a voltage V_{be} as a base-to-emitter voltage of the n-p-n transistor 10, the current I₁₀ can be expressed as:

$${I}_{10} ≅ \frac{( {V}_{C} - {V}_{A} - {V}_{be} )}{{R}_{30}} \qquad ( 3 )$$

Consequently, when the voltage across the low-side capacitor 300 is higher than the voltage across the high-side capacitor 200, the voltage V_{C} will be lower than the voltage V_{A}. This will turn off the n-p-n transistor 10 and turn on the p-n-p transistor 20. A current I₂₀ will be sunk from the low-side capacitor 300. With R₄₀ as the resistance of the resistor 40, and a voltage V_{be} as a base-to-emitter voltage of the p-n-p transistor 20, the current I₂₀ will also be proportional to the differential voltage.

It can be written as:

$${I}_{20} ≅ \frac{( {V}_{A} - {V}_{C} - {V}_{be} )}{{R}_{40}} \qquad ( 4 )$$

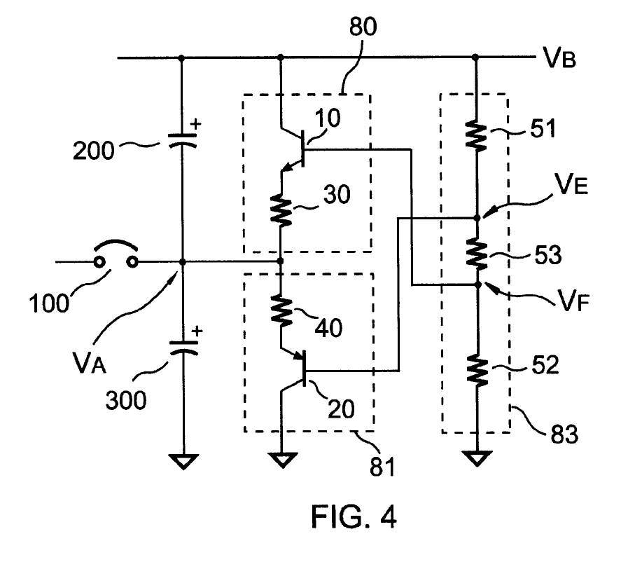

FIG. 4 shows another preferred embodiment of a balance apparatus for line input capacitors according to the present invention, in which a threshold resistor 53 is added to the circuit shown in FIG. 3. The threshold resistor 53 is connected in series with a high-side resistor 51 and a low-side resistor 52. The high-side resistor 51 is connected between the DC voltage V_{B} and the threshold resistor 53. The low-side resistor 52 is connected between the threshold resistor 53 and the ground reference. A base of an n-p-n transistor 10 is connected to a junction of the threshold resistor 53 and the low-side resistor 52. A base of a p-n-p transistor 20 is connected to a junction of the high-side resistor 51 and the threshold resistor 53. This generates a threshold voltage V_{EF}, which is given by,

$$\begin{matrix}{V}_{EF} = \frac{{R}_{53}}{{R}_{51} + {R}_{52} + {R}_{53}} \times {V}_{B} & ( 5 ) \\ {V}_{EF} = {V}_{E} - {V}_{F} & ( 6 )\end{matrix}$$

In the above equations, R₅₁, R₅₂ and R₅₃ are the resistance of the resistors 51, 52 and 53. V_{E} is a voltage at the base of the p-n-p transistor 20 and V_{F} is a voltage at the base of the n-p-n transistor 10.

The purpose of producing the threshold voltage V_{EF} is to reduce power consumption. When a differential voltage, which is the voltage difference of the high-side capacitor 200 and the low-side capacitor 300, is smaller than V_{EF}, both the n-p-n transistor 10 and the p-n-p transistor 20 will be turned off. Once the differential voltage is higher than V_{EF}, either the n-p-n transistor 10 or the p-n-p transistor 20 will be turned on to perform an appropriate adjustment.

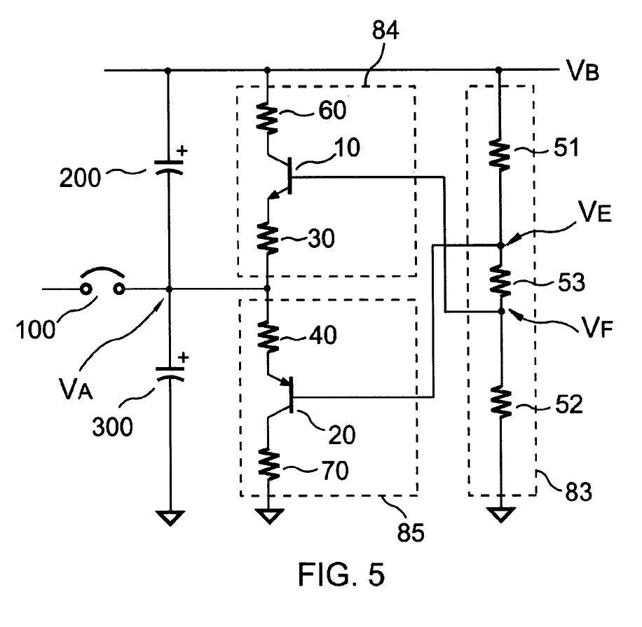

FIG. 5 shows another preferred embodiment of a balance apparatus for line input capacitors according to the present invention. An N-limit resistor 60 and a P-limit resistor 70 are added into the circuit shown in FIG. 4. The purpose of adding the N-limit resistor 60 and the P-limit resistor 70 is to protect an n-p-n transistor 10 and a p-n-p transistor 20 from over-current conditions or other abnormal conditions. The N-limit resistor 60 is inserted between the DC voltage V_{B} and a collector of the n-p-n transistor 10. The P-limit resistor 70 is inserted between a collector of the p-n-p transistor 20 and the ground reference.

It will be apparent to those skilled in the art that various modifications and variations can be made to the structure of the present invention without departing from the scope or spirit of the invention.

In view of the foregoing, it is intended that the present invention cover modifications and variations of this invention provided they fall within the scope of the following claims and their equivalents.

1. A balance apparatus for line input capacitors comprising:
a resistor network connecting a positive terminal of a high-side capacitor and a negative terminal of a low-side capacitor, wherein said resistor network includes a high-side resistor connected in series with a low-side resistor;
an N-current-sink connected in parallel with said high-side capacitor, wherein said N-current-sink includes an n-p-n transistor and an N-resistor;
a P-current-sink connected in parallel with said low-side capacitor, wherein said P-current-sink includes a p-n-p transistor and a P-resistor.

2. The balance apparatus according to claim 1, wherein the resistance of said high-side resistor is equal to the resistance of said low-side resistor.

3. The balance apparatus claimed in claim 1, wherein a negative terminal of said high-side capacitor is connected with a positive terminal of said low-side capacitor.

4. The balance apparatus claimed in claim 1, wherein a collector of said n-p-n transistor is connected to the positive terminal of said high-side capacitor, an emitter of said n-p-n transistor is connected to the negative terminal of said high-side capacitor via said N-resistor, and a base of said n-p-n transistor is connected to a junction of said high-side resistor and said low-side resistor.

5. The balance apparatus claimed in claim 1, wherein a collector of said p-n-p transistor is connected to the negative terminal of said low-side capacitor, an emitter of said p-n-p transistor is connected to the positive terminal of said low-side capacitor via said P-resistor, and a base of said p-n-p transistor is connected to the junction of said high-side resistor and said low-side resistor.

6. A balance apparatus for line input capacitors comprising:
a resistor network connecting a positive terminal of a high-side capacitor and a negative terminal of a low-side capacitor, wherein said resistor network includes a high-side resistor, a threshold resistor and a low-side resistor connected in series;
an N-current-sink connected in parallel with said high-side capacitor, wherein said N-current-sink includes an n-p-n transistor and an N-resistor;
a P-current-sink connected in parallel with said low-side capacitor, wherein said P-current-sink includes a p-n-p transistor and a P-resistor.

7. The balance apparatus claimed in claim 6, wherein the resistance of said high-side resistor is equal to the resistance of said low-side resistor.

8. The balance apparatus claimed in claim 6, wherein a collector of said n-p-n transistor is connected to a positive terminal of said high-side capacitor, an emitter of said n-p-n transistor is connected to a negative terminal of said high-side capacitor via said N-resistor, and a base of said n-p-n transistor is connected to a junction of said threshold resistor and said low-side resistor.

9. The balance apparatus claimed in claim 6, wherein a collector of said p-n-p transistor is connected to a negative terminal of said low-side capacitor, an emitter of said p-n-p transistor is connected to a positive terminal of said low-side capacitor via said P-resistor, and a base of said p-n-p transistor is connected to a junction of said high-side resistor and said threshold resistor.

10. A balance apparatus for line input capacitors comprising:
a resistor network connecting a positive terminal of a high-side capacitor and a negative terminal of a low-side capacitor, wherein said resistor network includes a high-side resistor, a threshold resistor and a low-side resistor connected in series;
an N-current-sink connected in parallel with said high-side capacitor wherein said N-current-sink includes an n-p-n transistor, an N-resistor and an N-limit resistor;
a P-current-sink connected in parallel with said low-side capacitor wherein said P-current-sink includes a p-n-p transistor, a P-resistor and a P-limit resistor.

11. The balance apparatus claimed in claim 10, wherein the resistance of said high-side resistor is equal to the resistance of said low-side resistor.

12. The balance apparatus claimed in claim 10, wherein a collector of said n-p-n transistor is connected to a positive terminal of said high-side capacitor via said N-limit resistor, an emitter of said n-p-n transistor is connected to a negative terminal of said high-side capacitor via said N-resistor, and a base of said n-p-n transistor is connected to a junction of said threshold resistor and said low-side resistor.

13. The balance apparatus claimed in claim 10, wherein a collector of said p-n-p transistor is connected to a negative terminal of said low-side capacitor via said P-limit resistor, an emitter of said p-n-p transistor is connected to a positive terminal of said low-side capacitor via said P-resistor, and a base of said p-n-p transistor is connected to a junction of said high-side resistor and said threshold resistor.
